(19) United States
(12) Patent Application Publication
(10) Pub. No.: US 2025/0107652 A1
(43) Pub. Date: Apr. 3, 2025

(54) Convertible Whistle Lid

(71) Applicant: Sarah Phoebe Ross, Roanoke, VA (US)

(72) Inventor: Sarah Phoebe Ross, Roanoke, VA (US)

(21) Appl. No.: 18/896,521

(22) Filed: Sep. 25, 2024

Related U.S. Application Data
(60) Provisional application No. 63/586,172, filed on Sep. 28, 2023.

(51) Int. Cl. A47J 27/212; A47J 36/06

(52) U.S. Cl. CPC A47J 27/212; A47J 36/06

(57) ABSTRACT

A device having a whistle unit comprising a tubular member and a base ring with an aperture. The base ring is configured to attach to the tubular member such that the passage of the tubular member aligns precisely with the aperture of the base ring, facilitating efficient steam flow. Additionally, the device includes a stem member connected to the whistle member, and a handle that is detachably positioned between the whistle member and the stem member. This design ensures optimal functionality and ease of assembly, providing a versatile solution for steam release and signaling applications.

### FIELD OF THE INVENTION

The present invention generally relates to household cooking implements, specifically focusing on lids used in this context. More specifically, the present invention introduces an innovative steam whistle apparatus that universally facilitates the monitoring of boiling water, compatible with any glass cook-pot lid without requiring modifications.

### BACKGROUND OF THE INVENTION

An innovative steam whistle apparatus that universally facilitates the monitoring of boiling water, compatible with any glass cook-pot lid without requiring modifications, is increasingly in demand.

Traditionally, tea kettles have served as essential kitchen appliances for boiling water, typically consisting of a container with a handle, a spout for pouring, and a lid to retain heat. These kettles are made from various materials, including stainless steel, copper, glass, ceramic, or heat-resistant plastics, and are designed for use on stovetops where they transfer heat from a burner to the water inside, allowing it to reach its boiling point.

There are examples such as cook pot lids with metal steam whistle units, where the whistle sound is regulated by a manually manipulated pin controlling steam flow. However, these units are often permanently affixed to the lid and not removable. Recent innovations, like multi-ported steam-powered whistles, have enhanced the utility of steam monitoring devices by offering more versatile and user-friendly features.

The present invention significantly improves upon these existing solutions by offering a detachable, universally compatible steam whistle apparatus, making the task of monitoring boiling water more convenient and adaptable to a wide range of cookware without permanent modifications.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a device incorporating a whistle unit with multiple components engineered for enhanced performance and durability. The whistle unit features a tubular member with external threads and a central passage, ensuring compatibility with complementary components for secure attachment. A base ring with an aperture is attached to the tubular member, aligning its passage with the ring's aperture to facilitate efficient fluid flow. A stem member is affixed to the whistle member to complete the unit.

The present invention includes a handle positioned between the whistle member and the stem member, contributing to usability and design efficiency. The whistle and stem members are constructed from heat-resistant plastics or metals, enhancing durability under high-temperature conditions. Furthermore, the design includes a tapered tip on the stem member to optimize fluid flow and a diameter smaller than that of the tubular member for streamlined fluid dynamics.

This device is crafted to offer superior performance in environments requiring reliable whistle signaling while maintaining structural integrity under thermal stress.

### BRIEF DESCRIPTION OF THE DRAWINGS

FIG. 1 is a schematic illustration of an embodiment of the present invention.

FIG. 2 is a schematic illustration depicting the installation of an embodiment of the present invention on a cookware item.

FIG. 3 is a schematic illustration of an embodiment of the present invention, showing the engagement of the tubular member with the base ring.

FIG. 4 is a schematic illustration of the tubular member according to one embodiment of the present invention.

FIG. 5 is a schematic illustration of the base ring as per an embodiment of the present invention.

FIG. 6 is a schematic illustration of the stem member in accordance with an embodiment of the present invention.

FIG. 7 is a schematic illustration of an embodiment of the present invention, sowing the stem cover.

FIG. 8 is a schematic illustration of the handle as described in an embodiment of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present invention, referred to as the “Glass Lid Steam Whistle,” is an innovative steam whistle apparatus designed for seamless integration with glass cook-pot lids. This apparatus allows steam to escape through the lid's steam vent, passing through the whistle's hollow stem and exiting via the attached whistle, thereby providing an audible alert when boiling occurs.

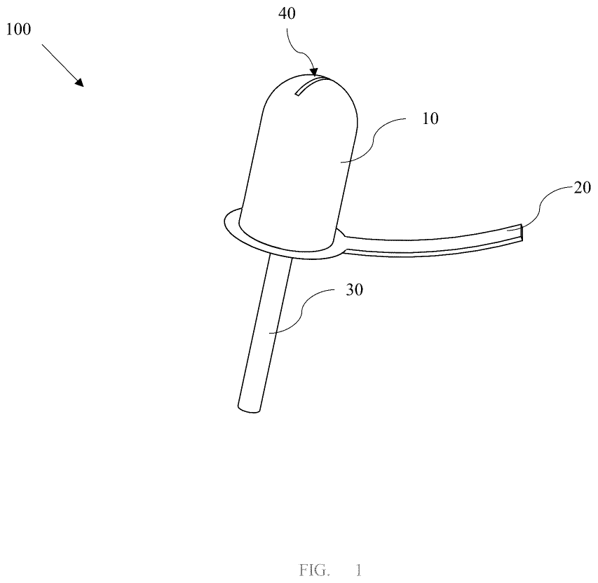

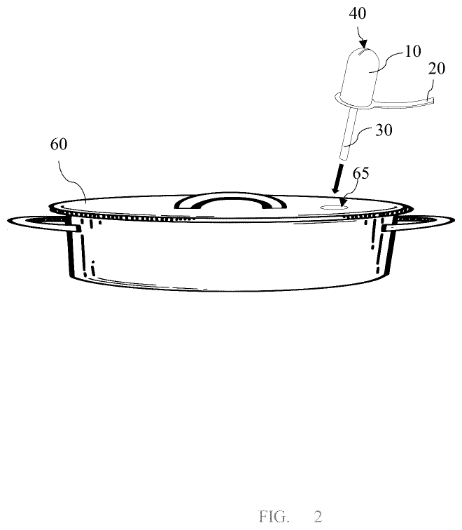

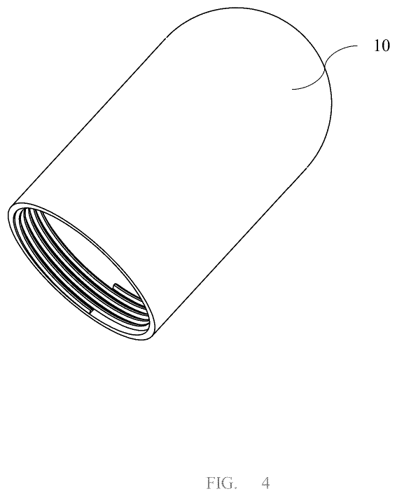

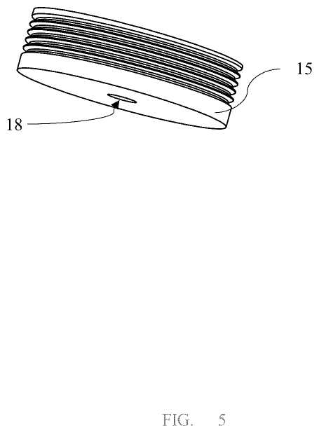

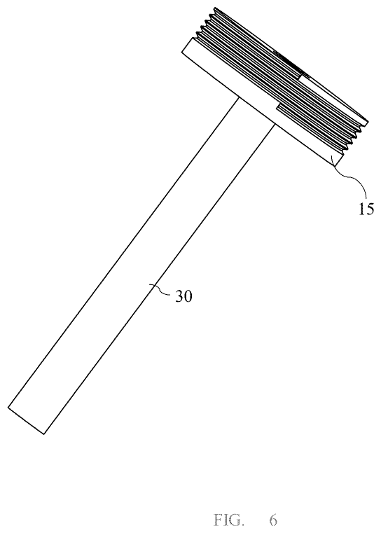

In one embodiment, as shown in FIGS. 1-8, the present invention provides a device 100 comprising a whistle unit 50, a stem member 30 attached to the whistle unit 50. In some embodiments, the device 100 may include a handle 20 attached to the whistle unit 50.

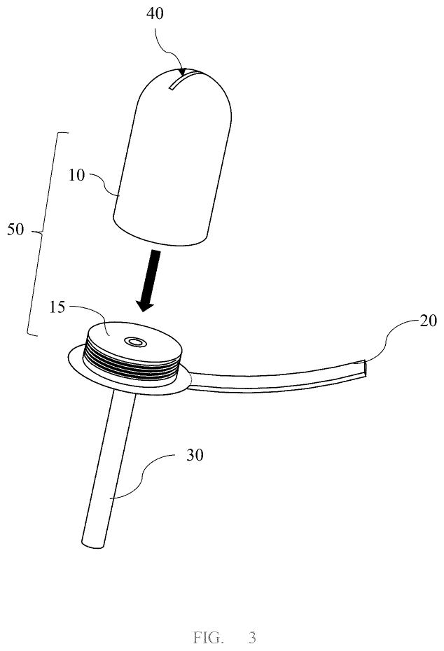

The whistle unit 50 may include a base ring 15 and a tubular member 10, as shown in FIG. 3.

### Base Ring 15

In one embodiment, the base ring 15 is configured as a cylindrical component featuring external threading, facilitating secure attachment to complementary components, such as a lid or supporting structure. In some embodiments, alternative attachment mechanisms, such as frictional attachments, may be employed to achieve a secure fit. These mechanisms ensure stability and a tight fit. The base ring 15 may incorporate a passage (aperture) 18 through which steam from the stem member can traverse, optimizing the flow of steam to the whistle unit 50.

### Tubular Member 10

In one embodiment, the tubular member 10, configured as an elongated cylindrical hollow rod with a dome structure with a whistle slot 40 on one end, is positioned above the base ring 15 and serves as the principal conduit for steam. It is designed to direct steam from the base ring 15 to the whistle slot 40, which may be located at the topmost point of the tubular member 10.

The tubular member 10 may comprise internal threads designed to engage with the threads present in the base ring 15. In certain embodiments, these threads may comprise a stopper or e-clip mechanism, featuring a protrusion within the tubular member and a corresponding groove in the mating base ring 15, or any other similar fastening mechanism can be used.

In a preferred embodiment, the tubular member 10 is hollow, thereby enabling efficient steam passage. The whistle slot 40 is strategically positioned to emit an audible signal when steam flows through, indicating boiling or elevated pressure conditions.

The whistle unit 50 is designed for straightforward assembly, with the tubular member 10 securely interfacing with the base ring 15, which includes a passage for steam from the stem member. This configuration permits attachment to a variety of surfaces or lids, offering a versatile solution for steam release monitoring. The integration of the base ring 15 and tubular member 10 ensures that the whistle unit 50 is both functional and adaptable to diverse applications.

The whistle unit 50 comprises a whistle 40 at one extremity and may be connected to a stem member with a tapered tip at the opposite end. In one embodiment, the stem member 30 is attachable to the whistle member 50 and is hollow and open at both ends, facilitating efficient steam passage. The tip of the stem member 30 can be ergonomically sized and tapered to ensure a universal fit into any glass lid's steam vent, thereby providing broad compatibility across various cookware 60.

To minimize steam condensation within the stem member 30, the length of the whistle's stem member 30 can be optimized to allow universal vent insertion while being sufficiently long to accommodate both the whistle 40 and an attached handle 20. The design of the tip ensures that the open end is adequately wide to permit sufficient steam flow for effective whistle operation, yet narrow enough to fit securely into any glass lid steam vent 65.

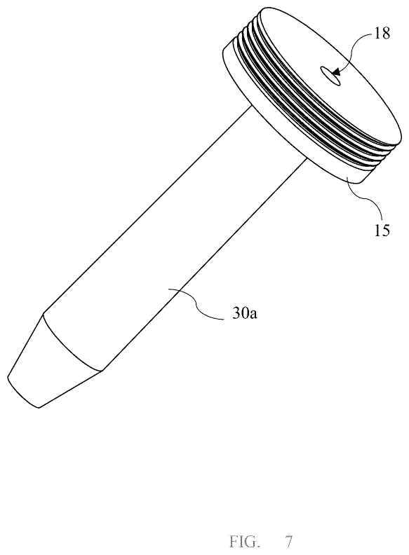

In certain embodiments, as illustrated in FIG. 7, the stem member 30 may include a stem cover 30a, which is designed to facilitate the adjustment of aperture size or to securely fit within the steam vent 65 of a cookware article. The stem cover 30a may be constructed from flexible materials, such as silicone, rubber, or other elastomeric compounds, to ensure adaptability and a snug fit within varying vent sizes.

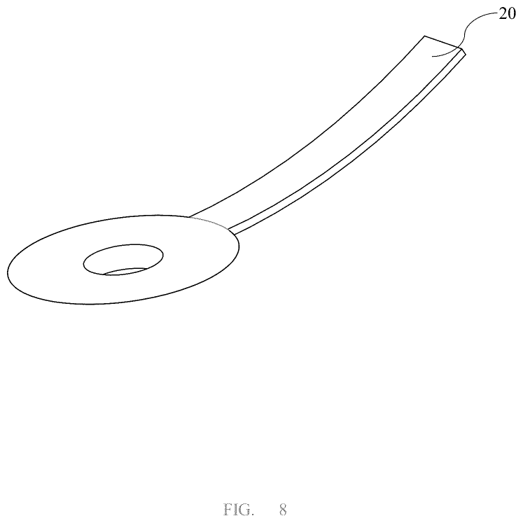

In one embodiment, the device may include a handle 20, as shown in FIG. 8. The handle 20 can be permanently/detachably attached to the whistle unit 50, providing safe handling during use. The handle 20 can be designed in various configurations, provided it does not compromise the functionality of the invention.

The materials used for the whistle unit 50 and stem member 30 can include heat-resistant plastics or metals, ensuring durability and safety for repeated use. The whistle unit 50 is also designed to be removable, allowing users to detach it when not in use, thereby offering flexibility and convenience.

Although the invention has been explained in relation to its preferred embodiment, it is to be understood that many other possible modifications and variations can be made without departing from the spirit and scope of the invention.

What is claimed is:

1. A device comprising:
a whistle unit including
a tubular member,
a base ring detachably attached to the tubular member, and
a stem member attached to the whistle unit.

2. The device as claimed in claim 1, further includes a handle attached in between the whistle unit and the stem member.

3. The device as claimed in claim 1, wherein the whistle unit and stem member include heat-resistant plastics.

4. The device as claimed in claim 1, wherein the whistle unit and stem member include heat-resistant plastics metals.

5. The device as claimed in claim 1, wherein the stem member includes a tapered tip.

6. The device as claimed in claim 1, wherein the diameter of the stem member is less than the diameter of the tubular member.

7. The device as claimed in claim 1, wherein the whistle unit includes one or more whistle slots.

8. A device comprising:
a whistle unit having a dome structure on one end including
a tubular member having internal threads and a passage placed in the center of the tubular member,
a base ring having an aperture and external threads, wherein the base ring is detachably attached to the tubular member such that the passage of the tubular member aligns with the aperture of the base ring, and
a stem member attached to the whistle unit.

9. The device as claimed in claim 8, further includes a handle attached in between the whistle unit and the stem member.

10. The device as claimed in claim 9, wherein the whistle unit and stem member include heat-resistant plastics.

11. The device as claimed in claim 9, wherein the whistle unit and stem member include heat-resistant plastics metals.

12. The device as claimed in claim 9, wherein the stem member includes a tapered tip.

13. The device as claimed in claim 8, wherein the diameter of the stem member is less than the diameter of the tubular member.

14. The device as claimed in claim 8, wherein the whistle unit includes one or more whistle slots.

15. A device comprising:
a whistle unit having a dome structure on one end including
a tubular member comprising an elongated hollow rod and a passage,
a base ring having a disk shape and an aperture, wherein the base ring is detachably attached to the tubular member such that the passage of the tubular member aligns with the aperture of the base ring,
a stem member attached to the whistle unit, wherein the stem member includes a stem cover; and
a handle detachably attached in between the whistle member and the stem member.

16. The device as claimed in claim 15, wherein the whistle unit and stem member include heat-resistant plastics.

17. The device as claimed in claim 15, wherein the whistle unit and stem member include heat-resistant plastics metals.

18. The device as claimed in claim 15, wherein the stem member includes a tapered tip.

19. The device as claimed in claim 16, wherein the diameter of the stem member is less than the diameter of the tubular member.

20. The device as claimed in claim 15, wherein the whistle unit includes one or more whistle slots.
